(19) United States
(12) Patent Application Publication
(10) Pub. No.: US 2009/0301285 A1
(43) Pub. Date: Dec. 10, 2009

(54) SUPPORT FOR STRAIGHT WIND INSTRUMENTS

(76) Inventor: Jose Ignacio Vildosola Erdociain, Lodosa-Navarra (ES)

Correspondence Address: OHLANDT, GREELEY, RUGGIERO & PERLE, LLP, ONE LANDMARK SQUARE, 10TH FLOOR, STAMFORD, CT, 06901, US

(21) Appl. No.: 10/585,257

(22) PCT Filed: Feb. 17, 2004
(86) PCT No.: PCT/ES2005/000077

§ 371 Date: Apr. 23, 2009

(51) Int. Cl. G10G 5/00

(52) U.S. Cl. 84/385 A; 84/453

(57) ABSTRACT

The instrument relates to a support provided with a first tubular guide element (1) consisting of two parts (2 and 3) having different diameters, which are joined in an intermediately staggered (4) manner. The upper end of the main guide element (1) is provided with a sleeve (6) which axially retains a nut which can detachably fix an inner pin guide (11) whose lower extremity bears a base (13) which is articulatedly connected to the legs or feet (14) of the support such that the latter can extend radially in an operative mode or which can be lowered onto the pin (1) in an inoperative mode, being accommodated in the lower sector (2) of the main guide element (1) which is provided with lower cavities (15) for coupling the feet (14) in an operative mode and provided with deep grooves (16) alternating with the cavities in order to allow pivoting towards the inside and outside of the arms (14) prior to rotation of the pin (11) by 45° in relation to the guide element (1).

### OBJECT OF THE INVENTION

This invention relates to a support for musical wind instruments, specifically for straight instruments, which allows keeping such instruments duly stabilized in the intervals in which they are not used.

The object of the invention is to obtain a support that is able to hold different wind instruments such as a piccolo, flute, clarinet, trumpet or others with full stability assurances.

The invention is therefore encompassed within the scope of musical accessories.

### BACKGROUND OF THE INVENTION

Both in concerts and rehearsals, there are breaks taken in the use of the instruments either because of rests or other reasons.

During said breaks, the musicians normally abandon their instruments so that the rest is more effective.

For this reason, and in addition to the classic case for storing and protecting the instrument, supports are known in the specific case of wind instruments which, resting on the floor, allow arranging the instrument in question on them, with the due stability and therefore security assurances for said instrument.

However, supports for wind instruments known to date have drawbacks mainly centered on two aspects: on one hand, said supports are very bulky, especially when attempting to provide them with suitable stability, which bulkiness is substantially maintained even when they are folded, and on the other hand it is necessary to provide a specific support for each type of instrument, i.e. a special support for a piccolo, another one for the flute, a different one for the clarinet, a different one for the trumpet, etc.

This means that when a musician works with two different wind instruments, in addition to the corresponding cases, he or she must have two different supports which furthermore, due to their size, cannot be housed inside said cases in the inoperative position, which would obviously be very desirable for easy transport.

### DESCRIPTION OF THE INVENTION

The support for straight wind instruments proposed by the invention resolves in a fully satisfactory manner the drawbacks set forth above in the different aspects discussed, such that a structurally simple single support with great functional stability and minimum dimensions in the inoperative position, is indistinctly usable with any of the previously mentioned wind instruments, providing the same stability features for each and every one of them.

To that end and more specifically, the support that is proposed is made up of a main guide, adopting a tubular configuration and having two sectors with different diameters, the top one of less diameter, with an axial and radial elevation suitable for allowing its housing inside a piccolo, a wide perimetral step being defined between both sectors for supporting said piccolo, and the upper sector of less diameter close to said step having ridges or ribs in the direction of its generatrices, acting as centering means of said piccolo.

Arranged on the top end of the main guide there is a perimetral groove for the coupling of a support casing for a nut, which remains thus coupled to the main guide, but has the ability to rotate; The top end of a guide shaft functioning inside the main guide penetrates and is fixed in this support casing, and joined to the end of the guide shaft there are a plurality of legs, preferably telescopic legs and four in number, susceptible to swiveling towards the guide shaft to a folded position, and in which they are housed in the main guide, around the guide shaft, or of being folded outwardly in the operative state. Fixing of the top end of the guide shaft to the support casing is done by means of a nut housed in said casing, without the ability to rotate with respect thereto, where the threaded top end of said shaft is screwed in.

According to the mobility provided for said legs, the main guide incorporates on its bottom end several notches with a semicircular elevation, in a number equal to the number of legs, equiangularly distributed, intended for receiving the respective legs in their operative position, and among such notches there are an equal number of grooves extending towards the vicinity of the top sector of less diameter of the main guide, grooves having the obvious purpose of allowing the swiveling in both directions of said legs between the folded and operative positions. After the legs exit the main guide through said grooves and once lowered to the operative position, they undergo a 45° rotation to be opposite to the notches where they are finally retained, when a new coupling of the top threaded end sector of the guide shaft to the nut housed in the support casing ending the top of the main guide occurs.

Fixed at the bottom end of the guide shaft there is a base to which a cover is joined. Assembled between the base and cover there is a ring traversing an opening which the legs have at their bottom end to act as an articulation shaft thereof.

When the instrument is a flute, the legs of the device act in their operating position as a stop for the bell of the musical instrument, while the bottom sector of the guide acts as a centering means. For the case of instruments such as the clarinet or trumpet with a bell of greater diameter, located on the step of the main guide there is a rubber adaptor provided with radial arms susceptible of being elastically deformed downwards, adapting to different internal diameters of the musical instrument and assuring perfect centering thereof in a coaxial position with respect to the guide shaft, as it likewise rests on the legs.

### DESCRIPTION OF THE DRAWINGS

To complement the description being made and for the purpose of aiding to better understand the features of the invention, according to a preferred practical embodiment thereof, a set of drawings is attached as an integral part of said description, in which the following is shown with an illustrative and non-limiting character:

FIG. 1 shows a side elevational view of the main guide part participating in the support for straight wind instruments constituting the object of this invention.

FIG. 2 shows a top plan view of the guide of the previous figure.

FIG. 3 shows a bottom plan view of the same guide

FIG. 4 shows a longitudinal section of the same guide according to section line A-A of FIG. 2.

FIG. 5 shows another similar section of the guide, now according to section line B-B of FIG. 3.

FIG. 6 shows a side elevational view of the guide shaft.

FIG. 7 shows a side elevational view of the casing for the nut ending the top end of the main guide.

FIG. 8 shows a bottom plan view of the casing of the previous Figure.

FIG. 9 shows a longitudinal section of the same casing, according to section line C-C of FIG. 8.

FIG. 10 shows a side elevational view of the base ending the bottom end of the guide shaft.

FIG. 11 shows a top plan view of the same base.

FIG. 12 shows a bottom plan view of the cover which is fixed to the base of FIGS. 10 and 11.

FIG. 13 shows a side elevational view of the cover of FIG. 12.

FIG. 14 shows a longitudinal sectional view of a detail of one of the telescopic rods forming the feet or legs articulately joined to the base of FIGS. 10 to 12.

FIG. 15 shows a side elevational view of a schematic representation of the support as a whole, in the folded situation.

FIG. 16 shows a cross-sectional view of a detail of the assembly represented in the previous figure, according to section line E-E of said figure.

FIG. 17 shows another cross-sectional view of a detail of FIG. 14, in this case according to section line F-F of said figure.

FIG. 18 shows a similar representation as FIG. 15, sectioned according to the same plane as FIG. 4, but in which the support is in the intermediate unfolded situation.

FIG. 19 shows detail A of FIG. 18, enlarged.

FIG. 20 shows a side elevational view of the support in the use situation.

FIG. 21 shows a top plan view of the assembly represented in the previous figure.

FIG. 22 shows a side elevational view of an adapter for instruments with a bell having a greater diameter.

FIG. 23 shows a bottom plan view of the adapter of FIG. 22.

FIG. 24 shows a diametrical section of the adapter according to section line G-G of FIG. 22.

FIG. 25 shows a similar representation as that of FIG. 20 but in which the support is shown with the adapter incorporated.

### PREFERRED EMBODIMENT OF THE INVENTION

In view of the indicated figures it can be observed how the support proposed by the invention is made up of a tubular main guide (1), in which there are two sectors of different outer diameters, a bottom sector (2), larger in diameter and in height, and a top sector (3), separated by an intermediate step (4).

The top sector (3) has a closed cylindrical side surface with a perimetral groove (5) close to its free end, intended for the fixing, by coaxial coupling by applying pressure, of a casing (6), particularly visible in FIGS. 7 to 9, with an inner housing (7) for a hexagonal nut, which will be discussed later, with cuts (8) in the direction of its generatrices, to facilitate the radial deformation of the casing at the level of its opening, where at the bottom it further has a circumferential alignment of inner lugs (9) intended for being inserted in said groove (5) of the main guide, to function as locking elements, preventing the accidental removal of said casing, but not its rotation.

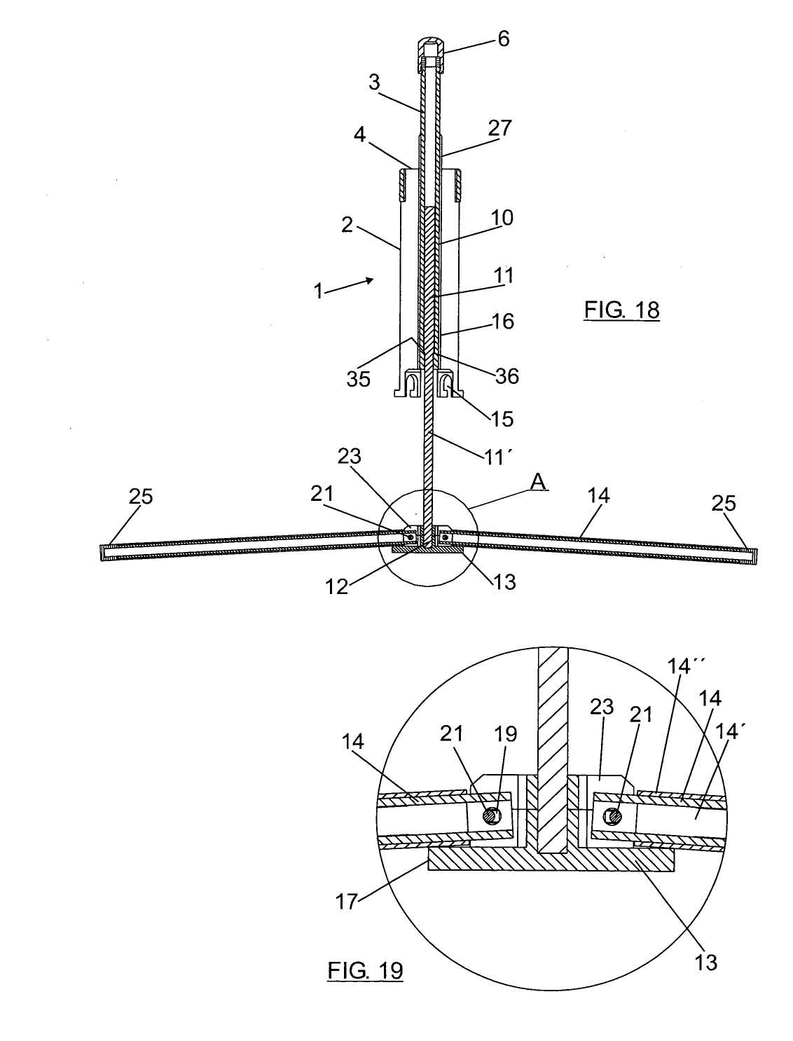

The nut arranged in the housing (7), which is immobilized with respect to the main guide (1) through said casing (6), is intended to receive the top threaded end (10) of a guide shaft (11), in which two sectors (11-11′) of different diameters are arranged, the bottom one ending in another sector (12) for its fixing to a base (13) by means of gluing or threading, the feet or legs (14) stabilizing the support on the ground in its use position articulately joined thereto, said base (13) limiting the downward swiveling of the legs (14), FIGS. 18 and 19, as will be explained below in more detail.

Returning again to the main guide (1), it incorporates on the free end of its bottom sector (2) of greater diameter four notches (15) having a stilted semicircular configuration, alternating with deep grooves (16) extending to the vicinity of the intermediate step (4) of the main guide (1).

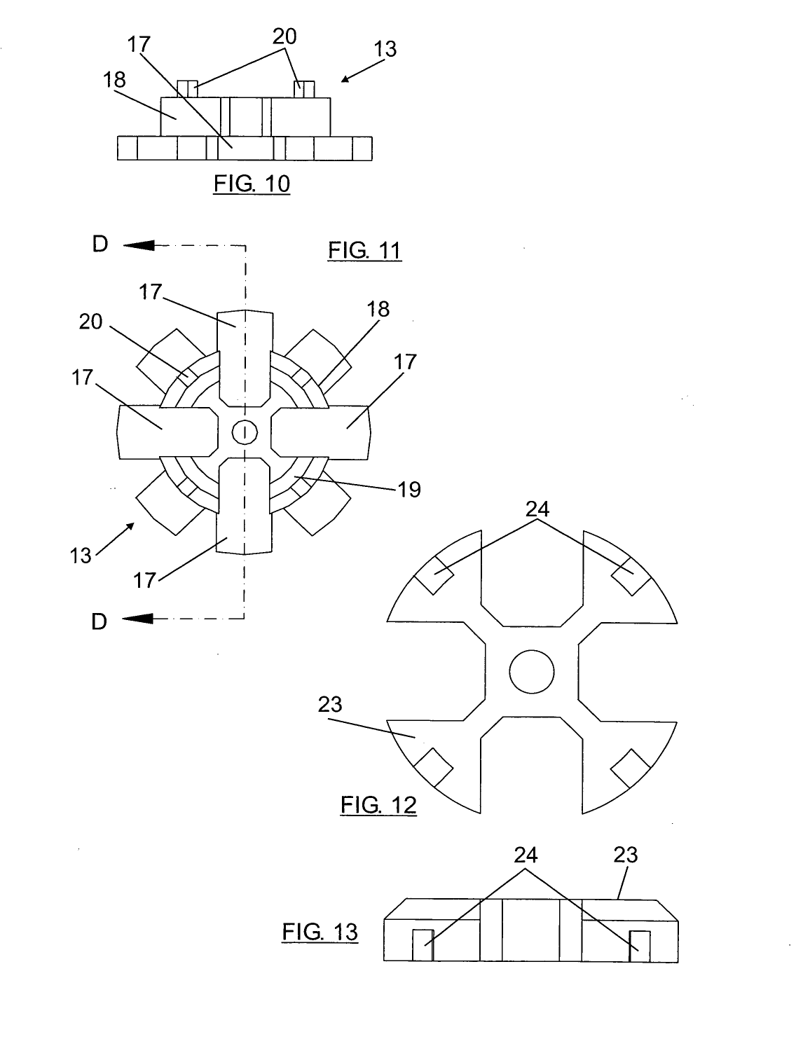

As can best be seen in FIGS. 10 to 13 and 18 and 19, the base 13 has four radial support planes 17, running between them are arched sections 18 of a cylindrical wall, on the top edge of which there is a concentric channel 19. A pivot 20 also projects from the top edge of each wall section.

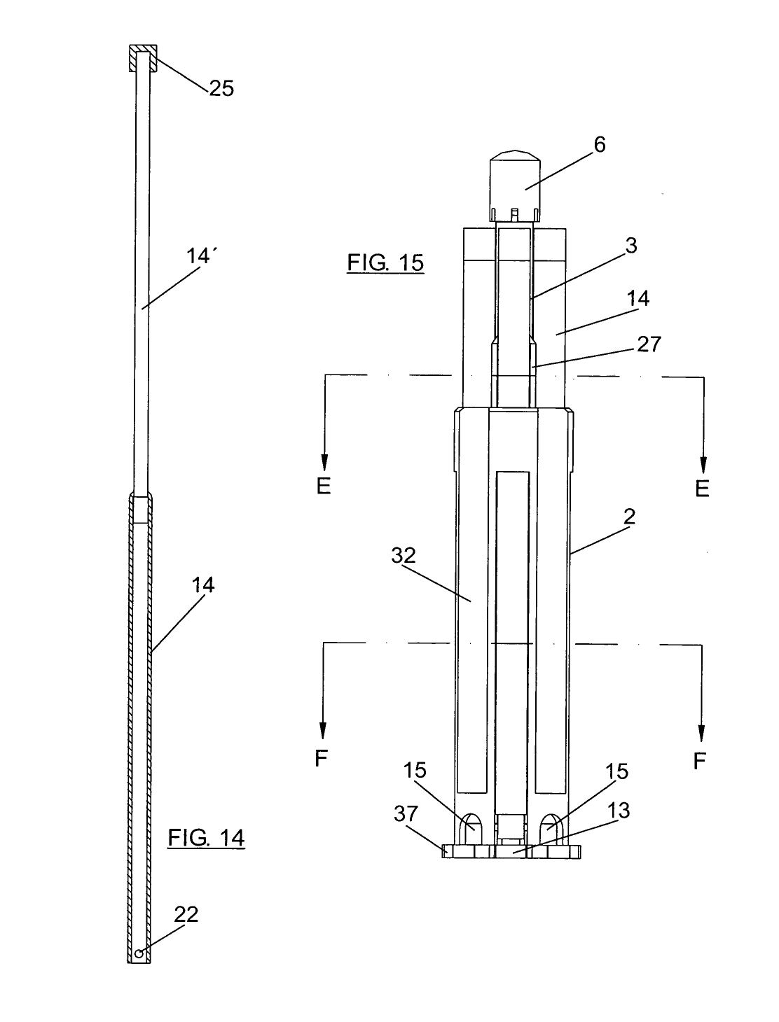

The legs 14 are joined to the base 13 by means of a ring 21, FIGS. 18 and 19, which is housed in the channel 19 of the base 13 and passes through an opening 22, FIG. 14, which each leg has on its end. The ring 21 is retained by means of a cover 23, FIGS. 12, 13 and 18, which is coupled and joined to the base 13, for example by means of gluing, and has housings 24 sized and positioned so as to receive the pivots 20 of the base 13.

The larger sector (2) of the main guide (1) has a suitable section for housing within it both the guide shaft (11) and the four legs (14) of the support when they are in the inoperative position shown in FIG. 15, in which said legs (14) substantially project upwards at the step (4) of the main guide (1) until being located in the vicinity of the nut casing (6), as can be observed in FIG. 15, which situation is kept stable insofar as in this position, the nut of the casing (6) is screwed to the top end (10) of the guide shaft (11).

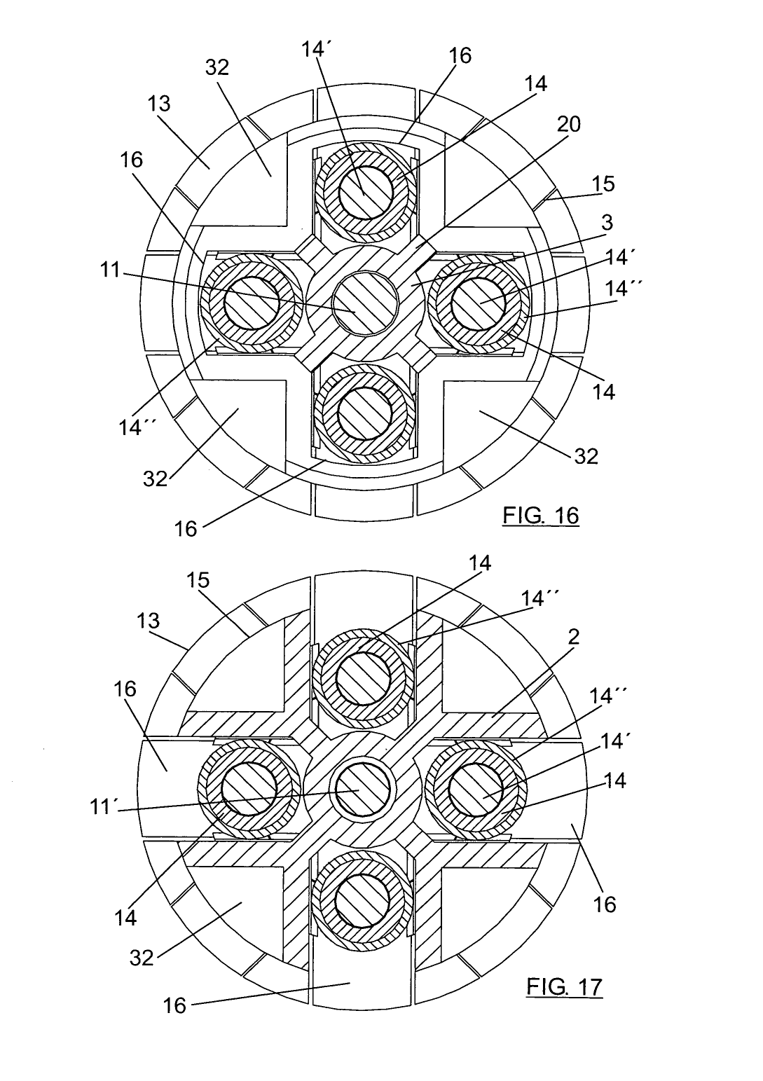

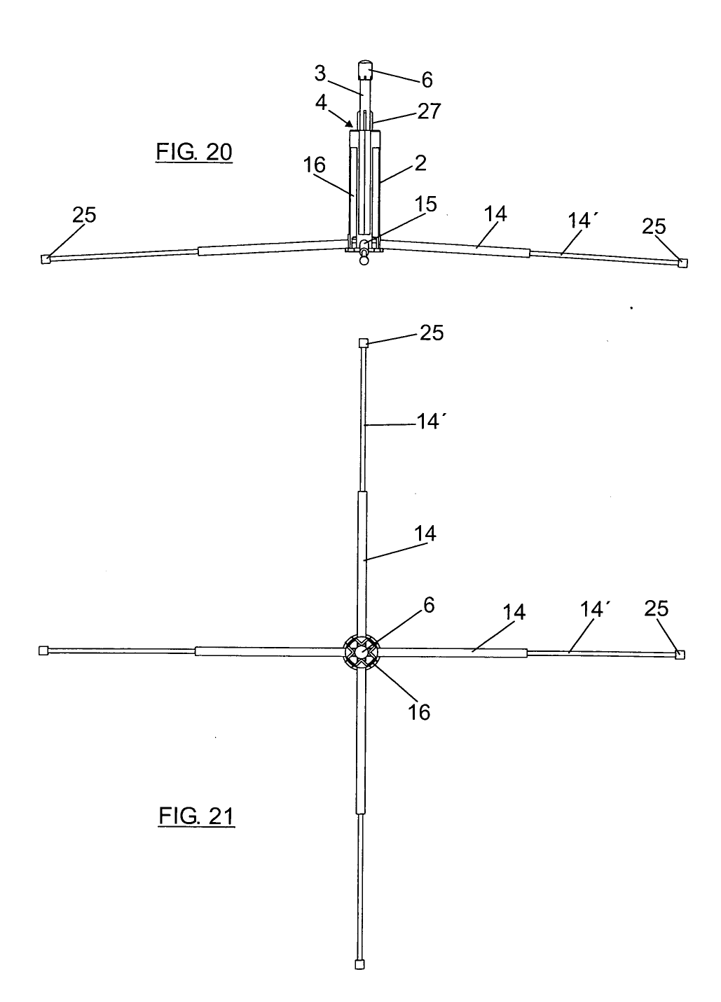

The legs or feet (14) participating in the support adopt a telescopic structuring, as shown in FIG. 14, based on two sections (14-14′) to provide the support with maximum stability, as is shown in FIG. 20, and at the end of section (14) they have an opening 22 for their articulation to the base 13 by means of a ring 21, and on the free end of section 14′ they are provided with a support pad 25. The outer section (14) can be provided with a protective outer covering (14″), as can be seen in FIGS. 16, 17 and 19.

According to the described structure and from the folded position shown in FIG. 15, in which the dimensions of the support are minimum and it can be housed inside the musical instrument case, it is sufficient to turn the nut casing (6) so that the guide shaft (11) is released, and by pulling on said casing (6) the main guide (1) moves in a downward direction with respect to the guide shaft (11) until the step (35) of the guide shaft rests against the step (36) of the main guide, FIGS. 4, 6 and 18, in which position the free ends (25) of the legs (14) reach the bottom of the grooves (16), at which time the legs (14) are susceptible of being folded towards the working position and, by provided a relative 45° movement with respect to the main guide (1) and the guide shaft (11), the legs (14) are then opposite to the stilted semicircular arches (15), at which time the main guide (1) in turn moves towards the legs (14) until the nut of the casing (6) reaches the top threaded sector (10) of the guide shaft (11), the fixing between these elements occurring again, and a tightening of the legs (14) against the bottom of the notches (15) occurring, locking them duly in the position shown in FIG. 20. Finally, section 14′ is completely extracted to the position shown in FIGS. 20, 21 and 25.

When the instrument is a piccolo, in this position the piccolo can be coupled on the top sector (3) of the main guide, resting on the step (4), being perfectly centered and stabilized by means of ridges or ribs (27) provided in said sector (3) of the main guide in its area close to the step (4) and the nut casing (6), or if the instrument is a flute, obviously with a greater diameter, the flute shall rest on the legs (14) themselves of the device and will be immobilized sideways through the dimensional adjustment therewith of sector (2) of a greater diameter of the main guide (1).

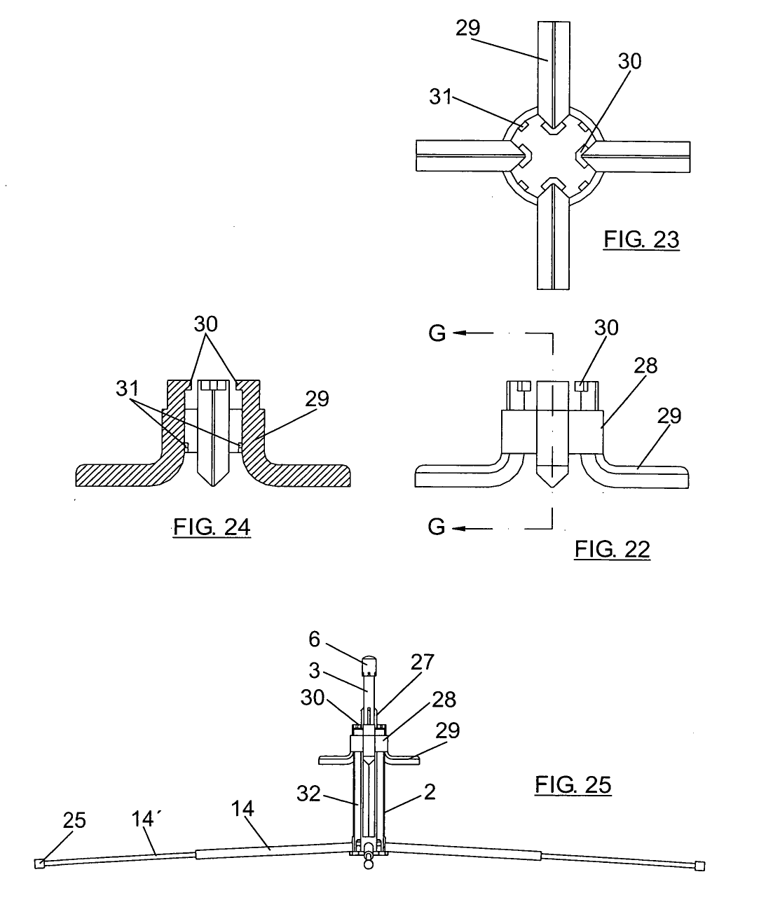

For the cases of instruments with a larger inner diameter, such as the clarinet or trumpet, the incorporation of the accessory shown in FIGS. 22 to 25 to the support has been provided, consisting of an adapter (28) coupled to the top end of the larger sector (2) of the main guide, which is configured by way of a ring externally coupled on section (2) of the main guide. This ring bears resiliently flexible bent arms (29) internally provided with a top bend (30). Internally projecting from the ring are small projections (31) in an alternating position with respect to the arms (29).

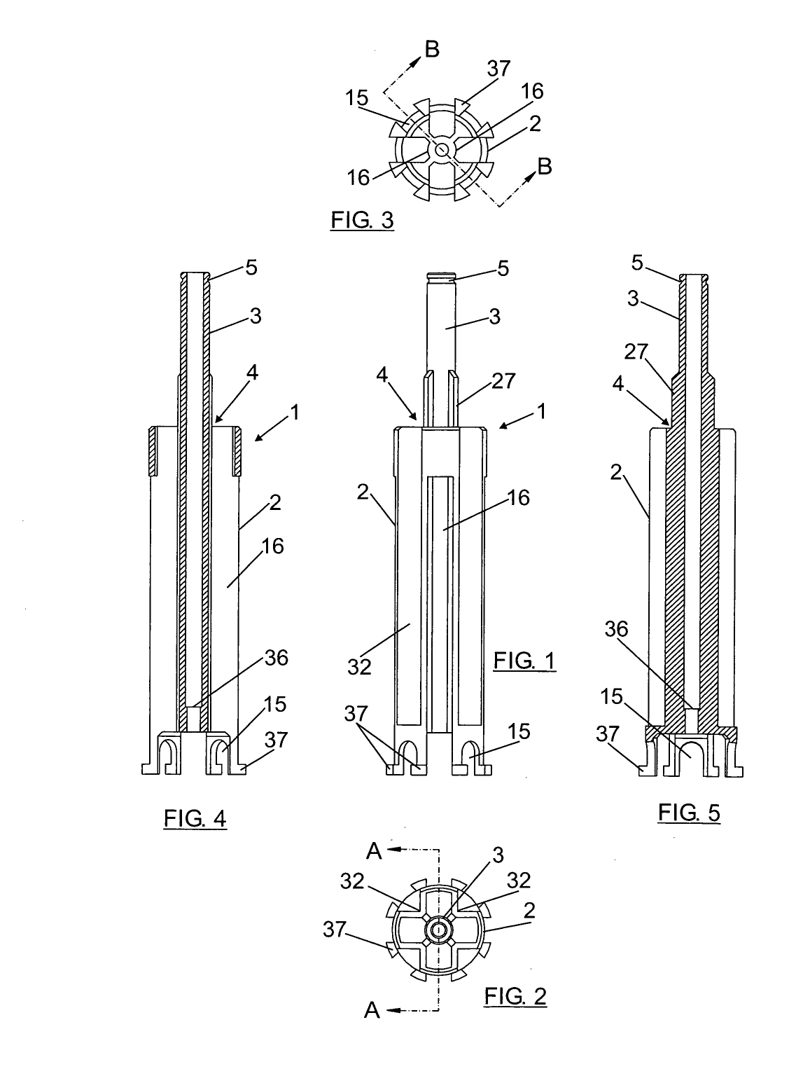

Through the top bend (30), the adapter (28) rests on the step (4) of the main guide, whereas the projections (31) are introduced in the top part of the grooves (16) of sector (2) of said guide, FIGS. 1 and 2.

In the position of FIG. 25, the outer section of the arms (29) will rest on the inner surface of the bell of the instrument, said arms bending and being housed on the channels (32) of the main guide until the adaptation thereof to the bell dimensions, acting as instrument centering elements that will rest on the legs (14).

In order to fold the support, following FIG. 20 or 25, begin by drawing in the legs, introducing section 14′ into section 14, and then loosening the nut screwed onto the top end of the guide shaft by means of rotating the casing 6.

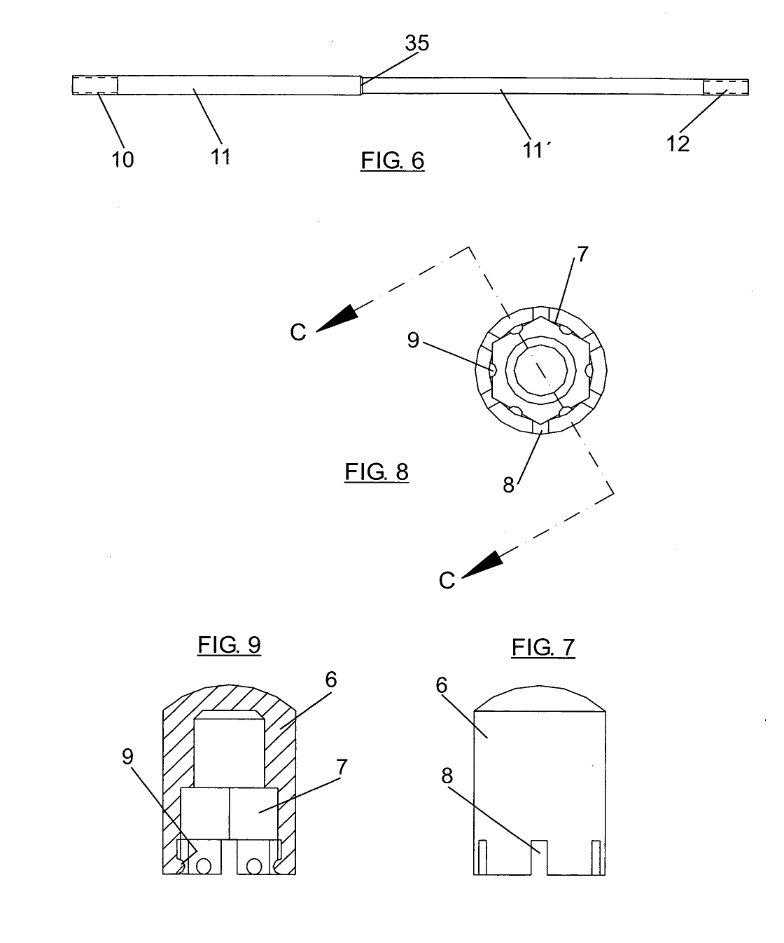

Then the main guide is lifted and turned 45° with respect to the guide shaft (11) and base (13), such that the legs (14) are opposite to the grooves (16), at which time they can be rotated downwards until being housed in the branches (16), at which time the main guide (1) can again move downwards to the position of FIG. 15, in which the legs project from the step (4), to again tighten the nut housed in the casing (6) that was screwed into the section (10) of the guide shaft (11), FIG. 6, the assembly being locked.

Finally, as can be seen in FIGS. 1 to 5, the guide (1) has on its bottom edge small radial flaps (37) which will act as stops on which the edge of the mouth of a flute will rest when the folded support, FIG. 15, is introduced in said instrument.

1. A support for a straight wind instrument allowing for vertical support of the instrument the support comprising:
a tubular main guide inside of which a guide shaft can axially move, folding legs articulately joined to a bottom end of the tubular main guide,
wherein the folding legs swivel between an inoperative folded position, in which the folding legs are housed in the tubular main guide, around the guide shaft, and another moved position for use, in which the folding legs radially project from the bottom end of the tubular main guide, and
wherein the tubular main guide and the guide shaft have removable fixing means which allow for a relative axial movement thereof for a folding/unfolding of the support.

2. The support for a straight wind instrument according to claim 1, wherein the removable fixing means between the tubular main guide and the guide shaft comprises a threaded sector arranged on a top end of the guide shaft and a nut housed in a casing, the casing being coupled by applying pressure with the ability to rotate in a perimetral groove disposed in a top end of the tubular main guide.

3. The support for a straight wind instrument according claim 2, further comprising:
a bottom sector of the tubular main guide having a first length and a first diameter, the bottom sector internally housing the folding legs in a folded position, and
a top sector of the tubular main guide, having a second length and a second diameter,
wherein the first length is greater than the second length and the first diameter is greater than the second diameter, and
wherein the bottom sector and the top sector define a perimetral step for supporting smaller instruments, further provided with side ridges which, together with the casing, define the means for correct centering of the instrument.

4. The support for a straight wind instrument according to claim 3, further comprising:
distributed notches equiangularly distributed notches having a stilted semicircular configuration, the notches being provided from an edge of a bottom wall of the bottom sector, the notches coinciding in number with the folding legs which the support incorporates, and
grooves being arranged between the notches, the grooves extending to the vicinity of perimetral step the grooves having sufficient width to allow receiving therein the folding legs during the folding/unfolding of the support.

5. The support for a straight wind instrument according to claim 1, further comprising a base on a bottom end of the guide shaft, said base housing a ring for the articulation of the folding legs the ring being retained by means of a cover fixed to the base.

6. The support for a straight wind instrument according to claim 4,
wherein the folding legs are telescopic, wherein when the folding legs are in a maximum retracted position, the folding legs have slightly less length than the tubular main guide, the folding legs being housed in the grooves of the bottom sector in the inoperative folded position of greater diameter of said guide, the folding legs being externally adapted to the top sector, the folding legs traversing openings operatively arranged on the perimetral step which demarcates both the too sector and the bottom sector of the tubular main guide.

7. The support for a straight wind instrument according to claim 1, further comprising radial flaps extending from a bottom edge of the support, the radial flaps limiting penetration of the support in a mouth of the instrument.

8. The support for a straight wind instrument according to claim 4, further comprising:
an adapter coupled to the bottom sector, the adapter being elastically deformable, the adapter allowing for an inner surface of the instrument to be centered thereon, the adapter having arms including an inner top bend for resting on the perimetral step; and
projections internally projecting from the support that are intended to be introduced in the top part of the grooves of the bottom sector of the tubular main guide.

9. The support for a straight wind instrument according to claim 1, wherein the guide shaft and a housing of the tubular main guide are provided with opposite peripheral steps resting on one another so as to limit a maximum extraction position of the tubular main guide with respect to the guide shaft.
